(19) United States
(12) Patent Application Publication
(10) Pub. No.: US 2006/0078375 A1
(43) Pub. Date: Apr. 13, 2006

(54) Fixing devices

(75) Inventors: Chang-Hao Lee, Taipei City (TW); Chi-Sheng Yin, Taipei City (TW); Ching-Yu Chen, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTek Computer Inc.

(21) Appl. No.: 11/208,253

(22) Filed: Aug. 19, 2005

(30) Foreign Application Priority Data
Oct. 11, 2004 (TW) 93130726

(51) Int. Cl. F16D 1/00

(52) U.S. Cl. 403/353

(57) ABSTRACT

A fixing device. A main body includes a first end surface and a second end surface which are sited oppositely. A hook is connected to the first end surface of the main body. A retardant portion is on the second end surface of the main body. An engaging groove is on the main body, adjacent to the retardant portion.

### BACKGROUND

The invention relates to a fixing device, and in particular to a fixing device using a hook.

A main board of a computer host is normally fixed to a housing by multiple bolts. The bolts, however, cause inconvenience in assembly and increase assembly time and cost thereof.

Hence, there is a need for a fixing device providing a specific profile to fast and easily fix a main board to a computer host. The assembly or manufacturing time of the computer host can be reduced.

### SUMMARY

An exemplary embodiment of a fixing device comprises a main body, a hook, a retardant portion, and an engaging groove. The main body comprises a first end surface and a second end surface opposite thereto. The hook is connected to the first end surface of the main body. The retardant portion is sited on the second end surface of the main body. The engaging groove is formed on the main body and adjacent to the retardant portion.

The hook further comprises a curved connecting portion connected to the first end surface of the main body.

The hook further comprises an abutting portion connected to the curved connecting portion, located above the first end surface of the main body, and separated from the first end surface by a predetermined distance.

The hook further comprises a curved recess between the curved connecting portion and the abutting portion and facing the first end surface of the main body.

The retardant portion protrudes from the main body and is parallel to the first and second end surfaces.

The main body further comprises a substantially rectangular solid.

The main body, hook, retardant portion, and engaging groove are formed integrally, by extrusion, of 6061 aluminum-based alloy or Cr—Mo hot-work tool steel.

### DESCRIPTION OF THE DRAWINGS

The invention can be more fully understood by reading the subsequent detailed description and examples with references made to the accompanying drawings, wherein:

FIG. 1A is a schematic front view of an embodiment of a fixing device;

FIG. 1B is a schematic right side view of FIG. 1A;

FIG. 1C is a schematic bottom view of FIG. 1A;

FIG. 2A shows a fixing device fixed on a housing;

FIG. 2B shows operation resulting from FIG. 2A;

FIG. 2C shows operation resulting from FIG. 2B;

FIG. 3A shows a main board fixed on a housing by means of a fixing device;

FIG. 3B shows operation resulting from FIG. 3A; and

FIG. 3C shows operation resulting from FIG. 3B.

### DETAILED DESCRIPTION

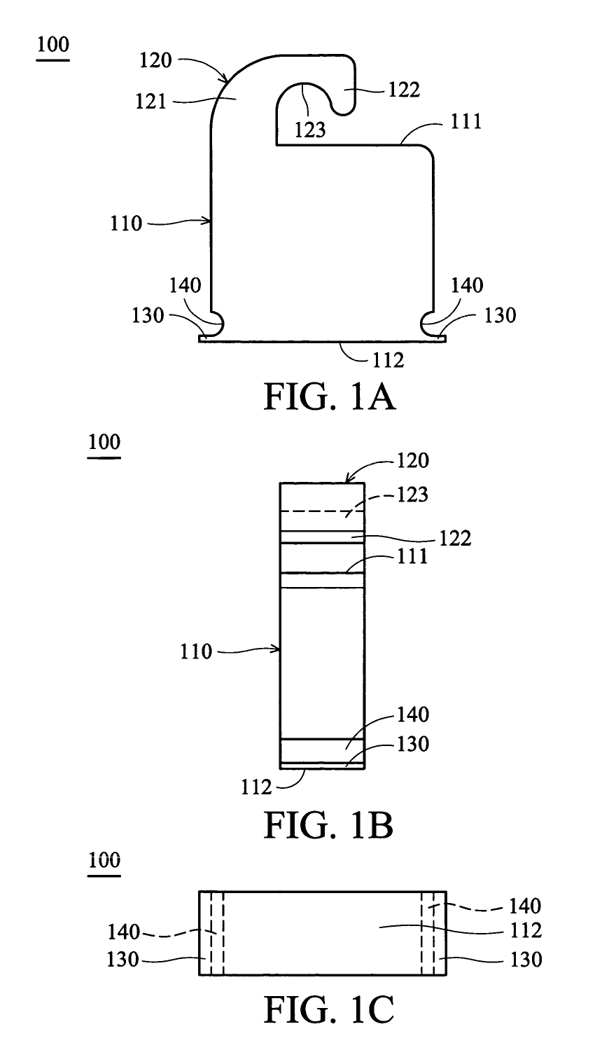

Referring to FIGS. 1A, 1B, and 1C, a fixing device 100 comprises a main body 110, a hook 120, two retardant portions 130, and two engaging grooves 140.

The main body 110 comprises a first end surface 111 and a second end surface 112 opposite thereto. Here, the main body 110 comprises a substantially rectangular solid, although other profiles are also possible, and is not limited thereto.

The hook 120 is connected to the first end surface 111 of the main body 110 and comprises a curved connecting portion 121, an abutting portion 122, and a curved recess 123. Specifically, the hook 120 is connected to the first end surface 111 of the main body 110 by way of the curved connecting portion 121 thereof. The abutting portion 122 is connected to the curved connecting portion 121. The curved recess 123 is between the curved connecting portion 121 and the abutting portion 122. Specifically, the abutting portion 122 is located above the first end surface 111 of the main body 110 and separated from the first end surface 111 by a predetermined distance, facing the first end surface 111.

The retardant portions 130 are on the second end surface 112 of the main body 110 and opposite sides of the main body 110, respectively. Specifically, as shown in FIG. 1A, the retardant portions 130 protrude from the main body 110 and are parallel to the first end surface 111 and second end surface 112, respectively.

The engaging grooves 140 are on the main body 110, each adjacent to each retardant portion 130.

Since the fixing device 100 is applied to fix a main board on an aluminum housing of a host and is first fixed on the aluminum housing, the hardness of the fixing device 100 must exceed that of the aluminum housing. The aluminum housing can thus engage the engaging grooves 140 of the fixing device 100, preventing damage to the fixing device 100 during fixing. Accordingly, the fixing device 100 (main body 110, hook 120, retardant portions 130, and engaging grooves 140) may comprise 6061 aluminum-based alloy or Cr—Mo hot-work tool steel, formed integrally by extrusion. Additionally, the hardness of the fixing device 100 may be enhanced by heat treatment, which may include quenching and tempering at 180-240° C. (preferably 210° C.) for 4-5 hours (preferably 4.5 hours).

The following description is directed to operation of the fixing device 100 fixing a main board (first board) on an aluminum housing (second board) of a host.

Although the fixing device 100 described here is applied to the main board on an aluminum housing of the host, the fixing device 100 can be applied to fix two boards and thus replace multiple bolts.

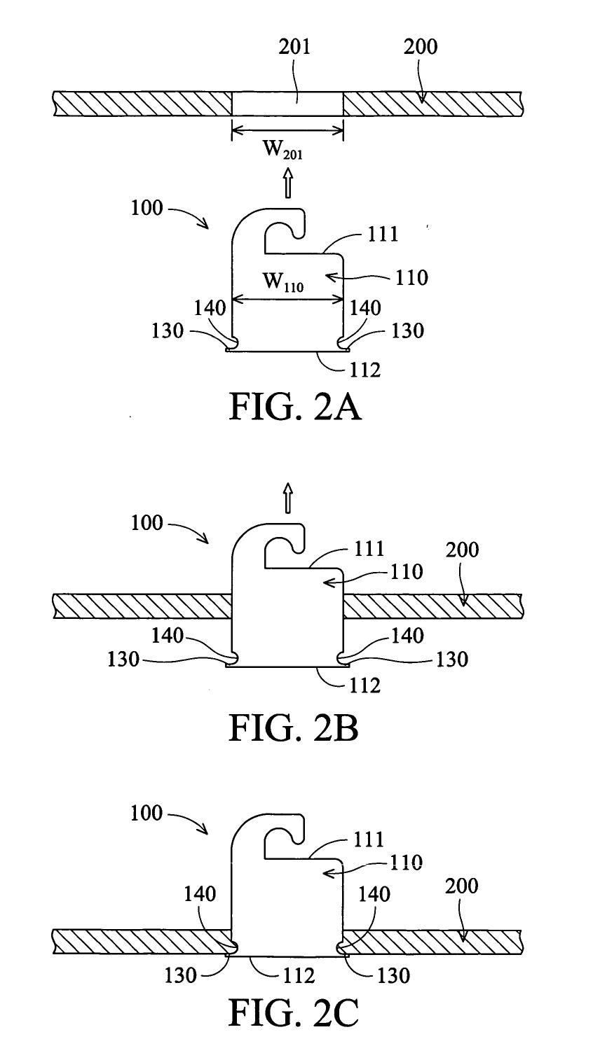

Referring to FIG. 2A, the fixing device 100 is aligned with a fixing hole 201 of an aluminum housing (second board) 200. The cross section of the fixing hole 201 corresponds to that of the main body 110 of the fixing device 100. The width W₂₀₁ of the fixing hole 201 is slightly less than the width W₁₁₀ of the main body 110. The hardness of the fixing device 100 exceeds that of the aluminum housing 200. As shown in FIG. 2A and FIG. 2B, the fixing device 100 (main body 110) is upwardly inserted into the fixing hole 201. At this point, since the width W₂₀₁ of the fixing hole 201 is slightly less than the width W₁₁₀ of the main body 110, the aluminum housing 200 slightly and resiliently deforms near the fixing hole 201 during insertion of the main body 110. The fixing device 100 continues to move upward until the retardant portions 130 on the second end surface 112 of the main body 110 abut the aluminum housing 200. At this point, the fixing device 100 cannot move in the fixing hole 201 and the deformed aluminum housing 200 immediately engages the engaging grooves 140 of the fixing device 100 by resilience, as shown in FIG. 2C. The fixing device 100 is thus securely fixed on the aluminum housing 200 and cannot move upward and downward.

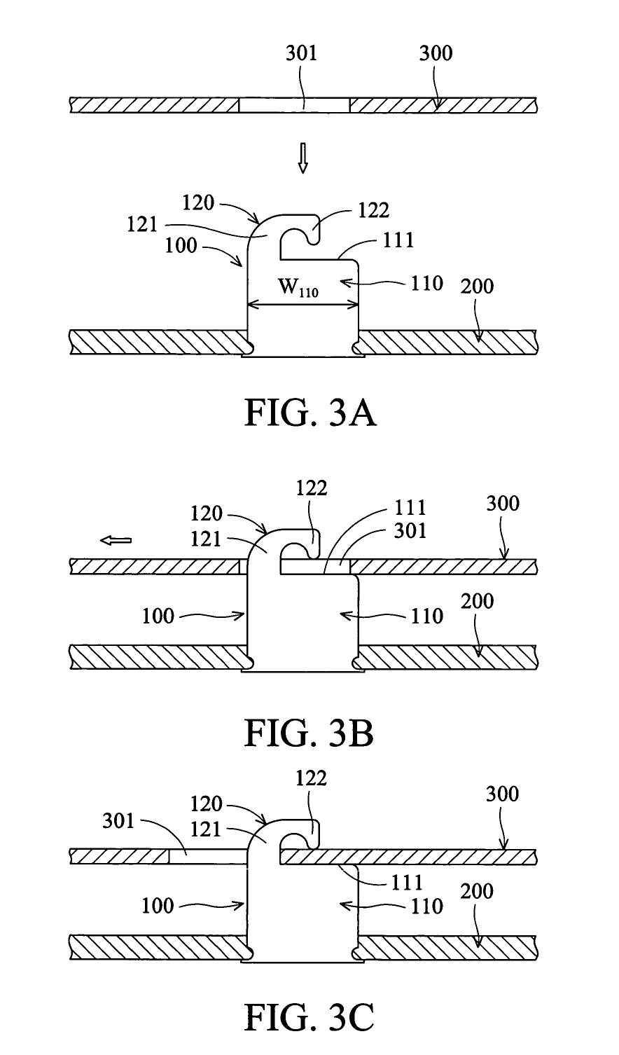

Referring to FIG. 3A, a main board (first board) 300 with another fixing hole 301 is placed on the fixing device 100. The fixing hole 301 can be, but is not limited to, a threaded hole. The diameter or width of the fixing hole 301 may be greater or slightly less than the width W₁₁₀ of the main body 110. The diameter or width of the fixing hole 301 must, however, be greater than or equal to the width of the hook 120, such that the hook 120 can pass through the fixing hole 301. As shown in FIG. 3A and FIG. 3B, the fixing hole 301 of the main board 300 moves toward the fixing device 100 until the main board 300 abuts the first end surface 111 of the main body 110. As shown in FIG. 3B and FIG. 3C, the main board 300 moves leftward until the inner wall of the fixing hole 301 abuts the curved connecting portion 121 of the hook 120. At this point, the main board 300 abuts the abutting portion 122 of the hook 120 and the first end surface 111 of the main body 110. Specifically, the aforementioned predetermined distance between the abutting portion 122 and the first end surface 111 can equal the thickness of the main board 300.

Accordingly, the fixing device 100 can be easily applied to a conventional main board on a housing without changing the profile of the (threaded) fixing holes thereof, eliminating use of multiple bolts, thereby potentially reducing assembly or manufacturing time of a computer host.

Additionally, a screwdriver (not shown) can be further applied to fix the main board 300 and aluminum housing 200 to secure fixing therebetween.

Moreover, in addition to connecting the abutting portion 122 to the main body 110, the curved connecting portion 121 can allow the aluminum housing 200 and main board 300 to be smoothly disposed on the fixing device 100 and prevent mold damage during extrusion manufacture of the fixing device 100. In another aspect, the curved recess 123 can prevent stress concentration resulting from extrusion of the fixing device 100, protecting the abutting portion 122 and mold from damage.

In conclusion, the fixing device of the invention has the following advantages. The fixing device is simplified, reducing manufacturing costs of the computer host. The fixing device can replace the conventional bolts, thereby simplifying the assembly of the computer host. Additional tools are not required when the fixing device fixes the main board to the housing of the computer host. The fixing device can be easily applied to a conventional main board on a conventional housing without changing the structures thereof. Since the main board can be fixed to the housing by only one fixing device or fewer fixing devices, the weight of the computer host can be reduced.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fixing device, comprising:
a main body, with a first end surface and a second end surface which are sited oppositely;
a hook connected to the first end surface of the main body;
a retardant portion on the second end surface of the main body; and
an engaging groove on the main body and adjacent to the retardant portion.

2. The fixing device as claimed in claim 1, wherein the hook further comprises a curved connecting portion connected to the first end surface of the main body.

3. The fixing device as claimed in claim 2, wherein the hook further comprises an abutting portion connected to the curved connecting portion, located above the first end surface of the main body, and separated from the first end surface by a predetermined distance.

4. The fixing device as claimed in claim 3, wherein the hook further comprises a curved recess between the curved connecting portion and the abutting portion and facing the first end surface of the main body.

5. The fixing device as claimed in claim 1, wherein the retardant portion protrudes from the main body and parallel to the first and second end surfaces.

6. The fixing device as claimed in claim 1, wherein the main body further comprises a substantially rectangular solid.

7. The fixing device as claimed in claim 1, wherein the main body, hook, retardant portion, and engaging groove are formed integrally.

8. The fixing device as claimed in claim 7, wherein the main body, hook, retardant portion, and engaging groove are formed integrally by extrusion.

9. The fixing device as claimed in claim 7, wherein the main body, hook, retardant portion, and engaging groove are formed integrally of 6061 aluminum-based alloy.

10. The fixing device as claimed in claim 7, wherein the main body, hook, retardant portion, and engaging groove are formed integrally of Cr—Mo hot-work tool steel.

11. A fixing device fixing a first board to a second board, comprising:
a main body, with a first end surface and a second end surface which are sited oppositely;
a hook connected to the first end surface of the main body;
a retardant portion on the second end surface of the main body and protruding from the main body; and
an engaging groove on the main body and adjacent to the retardant portion, wherein the fixing device is fixed on the second board by means of the retardant portion and engaging groove, and the first board is fixed between the first end surface of the main body and the hook.

12. The fixing device as claimed in claim 11, wherein the hook further comprises a curved connecting portion connected to the first end surface of the main body.

13. The fixing device as claimed in claim 12, wherein the hook further comprises an abutting portion connected to the curved connecting portion, located above the first end surface of the main body, and separated from the first end surface by a predetermined distance.

14. The fixing device as claimed in claim 13, wherein the hook further comprises a curved recess between the curved connecting portion and the abutting portion and facing the first end surface of the main body.

15. The fixing device as claimed in claim 11, wherein the main body further comprises a substantially rectangular solid.

16. The fixing device as claimed in claim 11, wherein the main body, hook, retardant portion, and engaging groove are formed integrally.

17. The fixing device as claimed in claim 16, wherein the main body, hook, retardant portion, and engaging groove are formed integrally by extrusion.

18. The fixing device as claimed in claim 16, wherein the main body, hook, retardant portion, and engaging groove are formed integrally of 6061 aluminum-based alloy.

19. The fixing device as claimed in claim 16, wherein the main body, hook, retardant portion, and engaging groove are formed integrally of Cr—Mo hot-work tool steel.

20. The fixing device as claimed in claim 16, wherein the hardness of the main body, hook, retardant portion, and engaging groove exceeds that of the second board.
